(19) United States
(12) Patent Application Publication
(10) Pub. No.: US 2018/0130025 A1
(43) Pub. Date: May 10, 2018

(54) Process and system for time management for employees

(71) Applicants: Michael Kampouris, Flushing, NY (US); Nick Kampouris, Flushing, NY (US)

(72) Inventors: Michael Kampouris, Flushing, NY (US); Nick Kampouris, Flushing, NY (US)

(21) Appl. No.: 15/343,284

(22) Filed: Nov. 4, 2016

(51) Int. Cl. G06Q 10/10; G06K 7/14; G06K 19/06; G06K 7/10

(52) U.S. Cl. CPC G06Q 10/1091; G06K 7/10297; G06K 19/06037; G06K 7/1417

(57) ABSTRACT

The current invention is system and application used by the employees to store and keep track of their individual work hours. There is a one-time registration upon opening the application using an employee identification number which is provided to the employer by the system. Once registered no other employee id can be used with the same device. Using both QR code and GPS location technologies to log the individual's clock-in and out times along with the location/address in which the scanning action was executed. The system provides a personal log of hours for the employees use.

### CROSS-REFERENCES TO RELATED APPLICATIONS (IF ANY)

None

### BACKGROUND

### 1. Field of the Invention

The present invention relates to a process to be used by the employees to store and keep track of their individual work hours and in more particularly for use with offsite or work from home employees.

### 2. Description of Prior Art

The US economy is becoming more diverse with more people being able to work away from their offices or permanently in field or home operations. Thus, these employees rarely if ever get in to the company's offices. According to most human resource analysis and estimates by the year 2020, 50% of the population will be working either from home or work the entire day without ever stepping into an office of the company that they work for. With so many people, working outside of the office and out of the classic mode of employee operations many human resource and other employee related activities will need to be changed. One issue that some employers still have in this new model of business is that they need to track or account for their employees hours of work.

There is still room for improvement in the art.

### SUMMARY OF THE INVENTION

The current invention is system and application used by the employees to store and keep track of their individual work hours.

The system, in the preferred embodiment, would work like a Smartphone application, this product would be available through the respective marketplace for Smartphone's.

In the system the Employers will be able to perform many actions via the website including registering the company/organization and be given the employee id numbers. They can add or delete employees. They would have access to a log of the full staff's hours in daily, weekly and monthly formats with the log being printable and savable.

The system is a mobile application is used by the employees to store and keep track of their individual work hours. There is a one-time registration upon opening the application using the employee identification number which is provided to the employer by the system.

Once registered, no other employee id can be used with the same device. A QR scanner is to be pointed at a QR code physically posted at the jobsite. QR codes will have been pre-coded with the job address from the system website and can be printed by the employer from there. Using both QR code and GPS location technologies the app will log the individual's clock-in and out times along with the location/address in which the scanning action was executed. The system will also have personal log of hours for the employees use. Employees will only have access to a log of their own work hours after logging in with their given employee identification number.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of the system;

FIG. 2 shows the flow of an employee using the system;

FIG. 3 displays the time sheet screen and

FIG. 4 displays the scanning of the QR code.

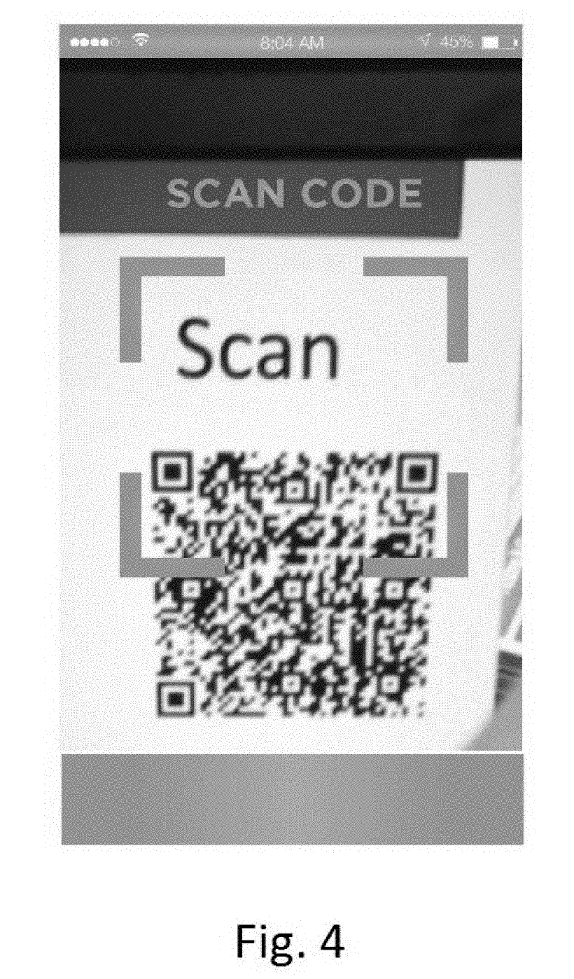

### DESCRIPTION OF THE PREFERRED EMBODIMENT

There are a number of significant design features and improvements incorporated within the invention.

The current invention is a system and application to be used by the employees to store and keep track of their individual work hours.

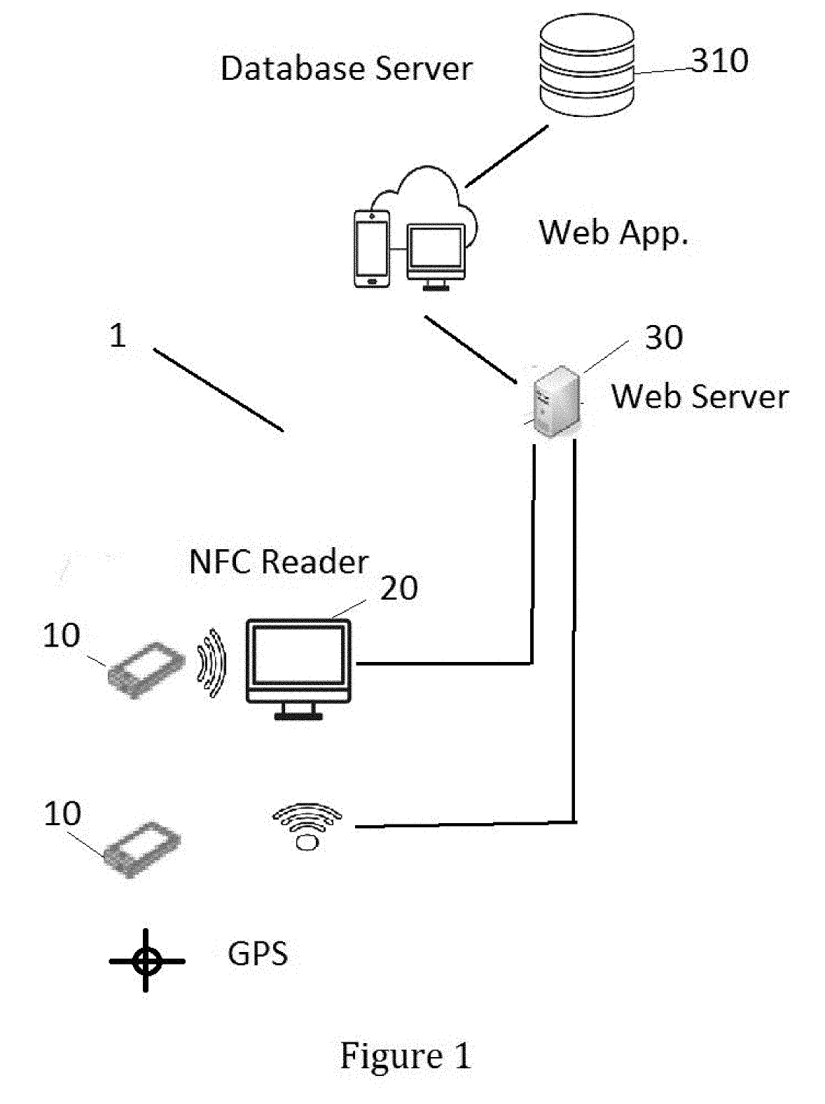

FIG. 1 displays the preferred embodiment of the system architecture 1 accessed through an Internet, Intranet and/or Wireless network. However, the system could be implemented on a device-to-device or client/server architecture as well.

The system 1, data and processing code can reside in the non-transitory memory 310 of the one or more computing devices 10. The computing device 10 can be any desktop, laptop, tablet, smart phone or general purpose computing device with an appropriate amount of memory suitable for this purpose but in the preferred embodiment it is a Smartphone. The system 1 in the preferred embodiment would be written to act like a smart phone application (app) where the different apps can communicate with each. The system 1 may work with a web server 30 as shown in FIG. 1, in parallel which each computing device 10 or Smartphone communicating with others within the system 1.

The system 1, data and processing code can reside in the non-transitory memory of the computing device 10 which can be connected to web server 30 and database server or 310. The system 1 in the preferred embodiment would be written to act like a smart phone application (app). The computing device 10 would have a geo-location GPS application or location means and can communicate with a near-field communications reader 20. Near-field communication (NFC) is a set of communication protocols that enable two electronic devices, such as the Smartphone 10 and the reader 20, to establish communication by bringing them within 4 cm (2 in) of each other.

Brief Overview

In the system the Employers will be able to perform many actions via the website including: Setting up and editing payment for services provided by the system 1. The employer can register the company/organization and be given the employee id numbers. They can add or delete employees. They would have access to a log of the full staff's hours in daily, weekly and monthly formats with the log being printable and savable.

The system is a mobile application is used by the employees to store and keep track of their individual work hours. There is a one-time registration upon opening the application using the employee identification number which is provided to the employer by the system 1. Once registered no other employee id can be used with the same device.

The QR scanner 20 is to be pointed at a QR code physically posted at the jobsite. QR codes will have been pre-coded with the job address from the system's website and can be printed by the employer from there.

Using both QR code and GPS location technologies the system 1 will log the individual's clock-in and out times along with the location/address in which the scanning action was executed.

The system 1 serving as a mobile app will also have personal log of hours for the employees use. Employees will only have access to a log of their own work hours after logging in with their given employee identification number.

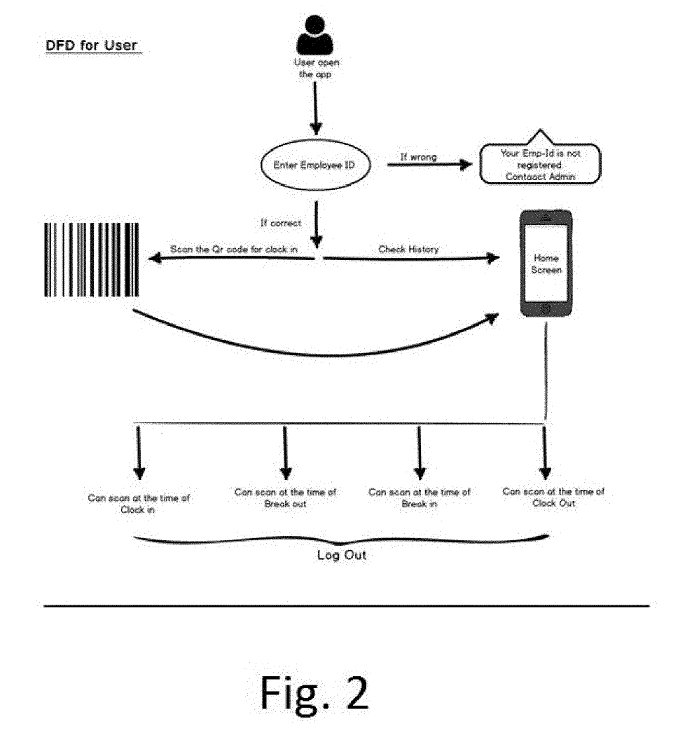

The process, as shown in FIG. 2, for the employee is as follows. The employee enters the system 1, which acts like a app. The employee enters their employee number. If wrong or if the employee does not have an employee number then the employee contacts the administration function.

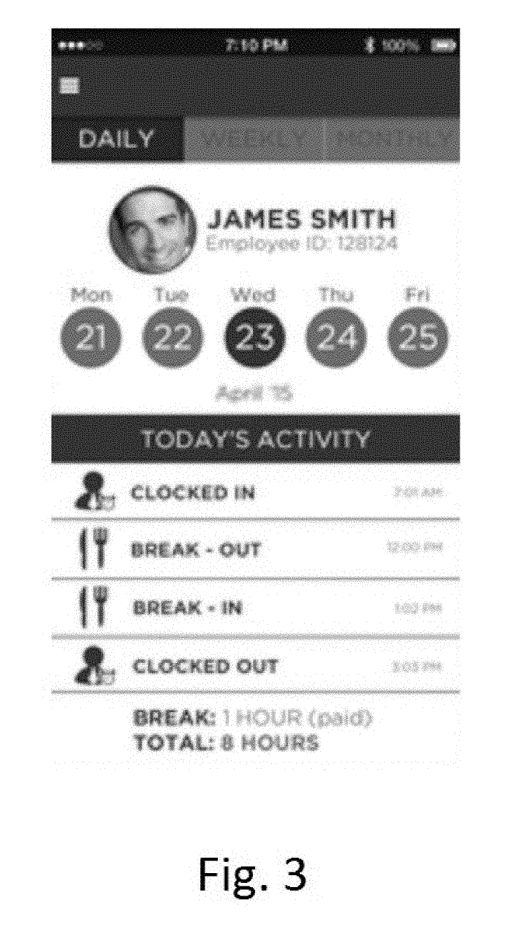

After entering the correct number, they scans the Qr code to check in. They can be checking in to work or they can be checking their work history. These will bring up the default home screen as shown in FIG. 3.

The employee scans the time they check in. They scan the time of their break. They scan the time that they return from their break. At the end of their work day, they scan themselves as clocking out. After clocking out the system 10 logs the employee out of the system 10.

The system 10 can create unique electronic Qr codes that employers can embed into work that will be done remotely. This serves the function that the employee can open his E-mails and work files, scan, work, and scan out when finished.

The system 1 can work without any network connectivity or WIFI connection. The computing device 10 will save the data as a packet when not connected to a network provider and then send the packets of information when the system gets a signal.

The system 10 will have one code used per location whether it is clocking in or out.

The system 1 will have a database 310 which can have the following information for the employer; Company Name, Credit Card Information, Choice of Monthly, Semi-Annual, Annual Subscription and Employee Registration such as name and phone number.

Employee Information on the database are; Employee Time in, Employee Break out, Employee Break in, Employee Time out and the employee's Daily, Weekly, Monthly Timesheet.

Every time the QR code is scanned it will trigger the geo-location.

The employee must Log in for the computing device 10 to be recognized by the system, but it is imperative in the preferred embodiment that there is no log out button, or log out option period. This to prevent multiple accounts clocking in from one device.

Operation

This next list of actions is to clarify how the system operates.

1) Employee walks into work

2) Employee takes out the computing device 10 like their phone and opens the system 1.

3) Without logging in after initial setup, a Qr reader automatically shows as first screen.

4) Employee points reader at Qr code at physical location

5) The scan stores clock in time and the employee starts to work.

This same function is repeated at clock out time.

Employee will first enter the Employee Id before going into the app. If the Employee Id is wrong he will get a prompt with a message “Your Emp-Id is wrong or not registered. Contact Admin if not registered else try again”.

If the Employee Id is correct the User will land to the scanning screen from where he can scan the QR code and check in. If the user only want to see his past record then he simply can click on an icon on the top of the screen and click on home from menu options, in response he will be redirect to the Home screen from where he can check his working hours on daily, weekly and monthly basis.

If an employee “A” use the Employee Id of employee “B” at the time of login then user “A” will get logged in even without scanning the code by himself. To avoid this fraud the system 1 append the device id of the phone when first time user enter into the system. In the case if the employee scans using different device then a onetime password will be sent to the registered employee mobile number from where he can verify his device and escape from this fraud.

The employee can Clock in only once. So as soon as he scans for the Clock in the Clock in scan button will get disabled.

A near-field communications reader 20 can be used with the computing device 10 to read the employee id number as well.

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
using an employee number to identify an employee,
reading that employee number to clock in the employee, and
using the employee number to clock out.

2. A system according to claim 1 using a QR code reader to read the employee number.

3. A system according to claim 1 using a near-field communications reader to read the employee number.

4. A system according to claim 1 having a connection to a network.

5. A system according to claim 4 having the computing device send data through the network.

6. A system according to claim 5 having the computing device saves the data as a packet.

7. A system according to claim 6 having the computing device sends the packet when connected to a network.

8. A system according to claim 1 having a plurality of jobsites.

9. A system according to claim 8 having each jobsite have a QR code.

10. A system according to claim 9 reading the QR code to identify the worksite.

11. A system according to claim 1 creating unique electronic Qr codes that are embedded within work files.

12. A process comprising;
Assigning an employee number to an employee;
Having an employee enters a worksite;
having the employee use a computing device;
starting the system;
having a QR reader;
pointing the QR reader at a Qr code at the worksite; and
storing the time.

13. A process according to claim 12 creating unique electronic Qr codes that are embedded within work files.

14. A process according to claim 12 repeating the same steps for the worker at the end of the work period.

15. A process according to claim 12 using a QR code to read the employee number.

16. A process according to claim 12 using a near-field communications reader to read the employee number.

17. A process according to claim 12 having a connection to a network and having the computing device send data through the network.

18. A process according to claim 17 having the computing device saves the data as a packet and sending the packet when connected to a network.

19. A process according to claim 12 having a plurality of jobsites.

20. A process according to claim 12 having each jobsite have a QR code.
